(19) United States
(12) Patent Application Publication
(10) Pub. No.: US 2026/0197639 A1
(43) Pub. Date: Jul. 9, 2026

(54) REASSOCIATION BETWEEN STATION AND ACCESS POINT

(71) Applicant: QUALCOMM Incorporated, San Diego, CA (US)

(72) Inventors: Bing LIU, Shanghai (CN); Ruiyi ZHANG, Shanghai (CN)

(21) Appl. No.: 18/865,457

(22) PCT Filed: Aug. 2, 2022
(86) PCT No.: PCT/CN2022/109635

§ 371 Date: Nov. 13, 2024

(51) Int. Cl. H04W 12/0431; H04W 12/06; H04W 12/106; H04W 60/02

(52) U.S. Cl. CPC H04W 12/0431; H04W 12/06; H04W 12/106; H04W 60/02

(57) ABSTRACT

Various aspects of the present disclosure generally relate to wireless communication. In some aspects, a station may transmit, to an access point and using a pairwise transient key (PTK) that is based at least in part on an Snonce and an Anonce, a reassociation request that indicates message integrity check (MIC) information. The station may receive, from the access point, a reassociation response that indicates MIC information. The station may perform a reassociation with the access point based at least in part on a receipt of the reassociation response. Numerous other aspects are described.

### FIELD OF THE DISCLOSURE

Aspects of the present disclosure generally relate to wireless communication and to techniques and apparatuses for reassociation between a station and an access point.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a station includes a memory and one or more processors, coupled to the memory, configured to: transmit, to an access point and using a pairwise transient key (PTK) that is based at least in part on an Snonce and an Anonce, a reassociation request that indicates message integrity check (MIC) information; receive, from the access point, a reassociation response that indicates MIC information; and perform a reassociation with the access point based at least in part on a receipt of the reassociation response.

In some implementations, an apparatus for wireless communication at an access point includes a memory and one or more processors, coupled to the memory, configured to: receive, from a station and based at least in part on a PTK that is derived using an Snonce and an Anonce, a reassociation request that indicates MIC information; transmit, to the station, a reassociation response that indicates MIC information; and perform a reassociation with the station based at least in part on the reassociation response.

In some implementations, a method of wireless communication performed by a station includes transmitting, to an access point and using a PTK that is based at least in part on an Snonce and an Anonce, a reassociation request that indicates MIC information; receiving, from the access point, a reassociation response that indicates MIC information; and performing a reassociation with the access point based at least in part on a receipt of the reassociation response.

In some implementations, a method of wireless communication performed by an access point includes receiving, from a station and based at least in part on a PTK that is derived using an Snonce and an Anonce, a reassociation request that indicates MIC information; transmitting, to the station, a reassociation response that indicates MIC information; and performing a reassociation with the station based at least in part on the reassociation response.

In some implementations, a non-transitory computer-readable medium storing a set of instructions for wireless communication includes one or more instructions that, when executed by one or more processors of a station, cause the station to: transmit, to an access point and using a PTK that is based at least in part on an Snonce and an Anonce, a reassociation request that indicates MIC information; receive, from the access point, a reassociation response that indicates MIC information; and perform a reassociation with the access point based at least in part on a receipt of the reassociation response.

In some implementations, a non-transitory computer-readable medium storing a set of instructions for wireless communication includes one or more instructions that, when executed by one or more processors of an access point, cause the access point to: receive, from a station and based at least in part on a PTK that is derived using an Snonce and an Anonce, a reassociation request that indicates MIC information; transmit, to the station, a reassociation response that indicates MIC information; and perform a reassociation with the station based at least in part on the reassociation response.

In some implementations, an apparatus for wireless communication includes means for transmitting, to an access point and using a PTK that is based at least in part on an Snonce and an Anonce, a reassociation request that indicates MIC information; means for receiving, from the access point, a reassociation response that indicates MIC information; and means for performing a reassociation with the access point based at least in part on a receipt of the reassociation response.

In some implementations, an apparatus for wireless communication includes means for receiving, from a station and based at least in part on a PTK that is derived using an Snonce and an Anonce, a reassociation request that indicates MIC information; means for transmitting, to the station, a reassociation response that indicates MIC information; and means for performing a reassociation with the station based at least in part on the reassociation response.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a Wi-Fi Protected Access II (WPA2) pre-shared key (PSK) with an Institute of Electrical and Electronics Engineers (IEEE) 802.11w disabled extended service set (ESS), in accordance with the present disclosure.

FIG. 5 is a diagram illustrating an example of a Wi-Fi Protected Access III (WPA3) Simultaneous Authentication of Equals (SAE) with an IEEE 802.11w enabled ESS, in accordance with the present disclosure.

FIG. 6 is a diagram illustrating an example of an ESS roaming scenario, in accordance with the present disclosure.

FIGS. 7-10 are diagrams illustrating examples associated with reassociation between a station and an access point, in accordance with the present disclosure.

FIGS. 11-12 are diagrams illustrating example processes associated with reassociation between a station and an access point, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

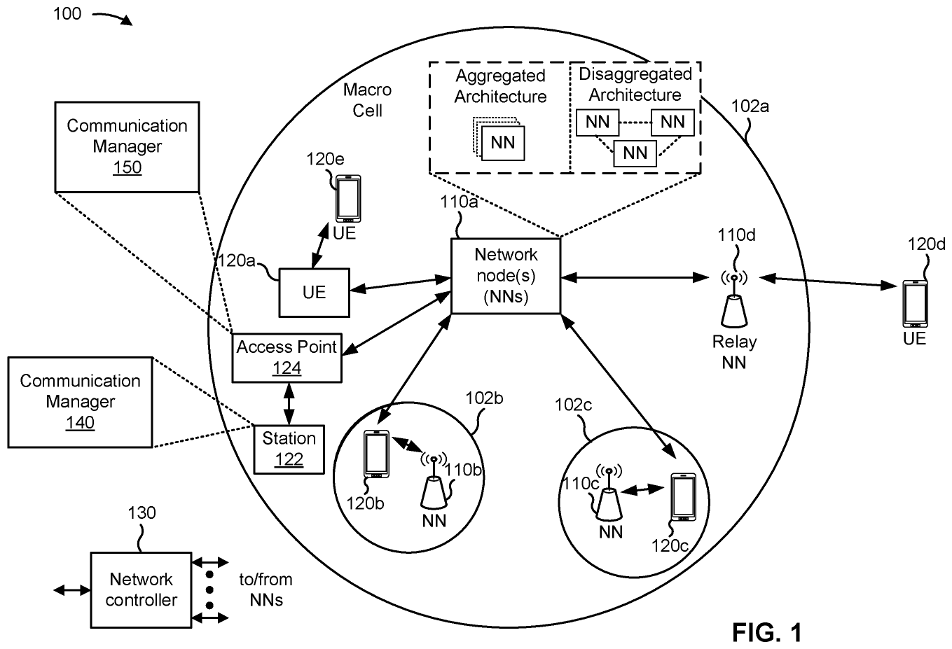

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a station (e.g., station 122) may include a communication manager 140. As described in more detail elsewhere herein, the communication manager 140 may transmit, to an access point and using a pairwise transient key (PTK) that is based at least in part on an Snonce and an Anonce, a reassociation request that indicates message integrity check (MIC) information; receive, from the access point, a reassociation response that indicates MIC information; and perform a reassociation with the access point based at least in part on a receipt of the reassociation response.

Additionally, or alternatively, the communication manager 140 may perform one or more other operations described herein.

In some aspects, an access point (e.g., access point 124) may include a communication manager 150. As described in more detail elsewhere herein, the communication manager 150 may receive, from a station and based at least in part on a PTK that is derived using an Snonce and an Anonce, a reassociation request that indicates MIC information; transmit, to the station, a reassociation response that indicates MIC information; and perform a reassociation with the station based at least in part on the reassociation response. Additionally, or alternatively, the communication manager 150 may perform one or more other operations described herein.

As indicated above, FIG. 1 is provided as an example. Other examples may differ from what is described with regard to FIG. 1.

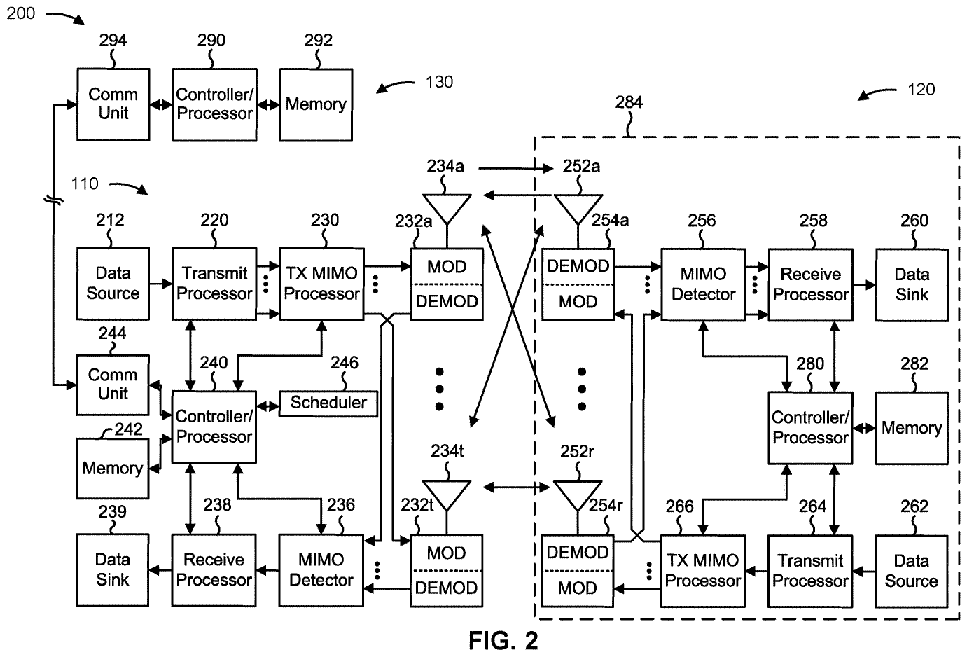

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

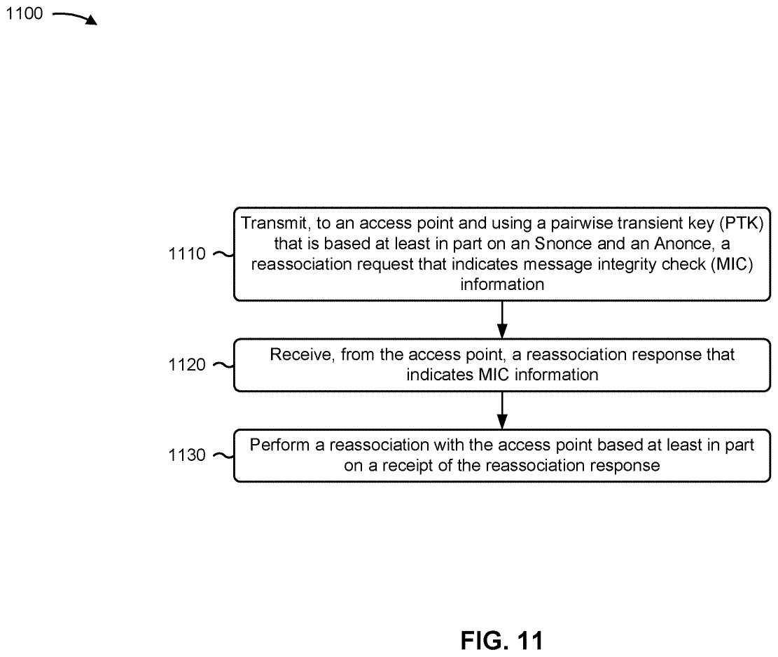

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 11-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 11-14).

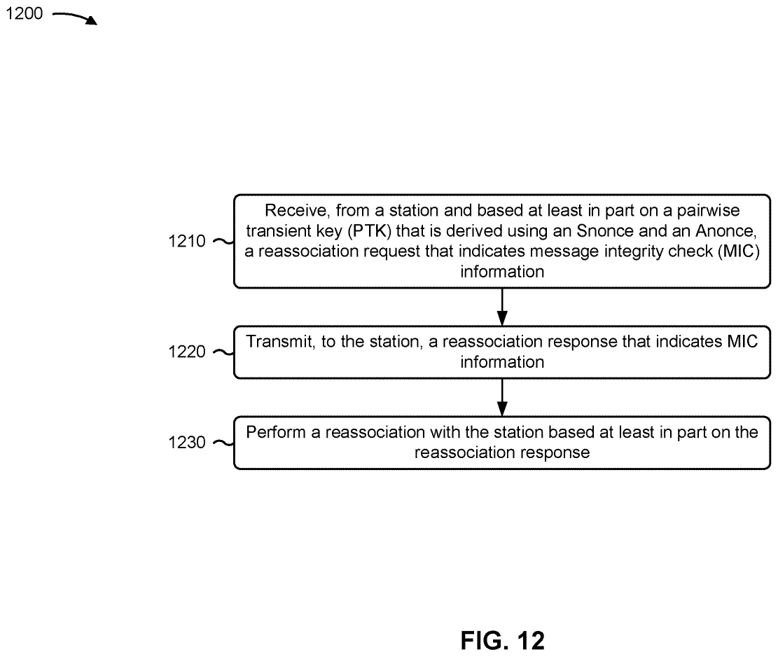

The controller/processor 240 of the network node 110, the controller/processor 280 of the UE 120, and/or any other component(s) of FIG. 2 may perform one or more techniques associated with reassociation between a station and an access point, as described in more detail elsewhere herein. In some aspects, the access point described herein is the base station 110, is included in the base station 110, or includes one or more components of the base station 110 shown in FIG. 2. In some aspects, the station described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a station (e.g., station 122) includes means for transmitting, to an access point and using a PTK that is based at least in part on an Snonce and an Anonce, a reassociation request that indicates MIC information; means for receiving, from the access point, a reassociation response that indicates MIC information; and/or means for performing a reassociation with the access point based at least in part on a receipt of the reassociation response. In some aspects, the means for the station to perform operations described herein may include, for example, one or more of antenna 252, modem 254, MIMO detector 256, receive processor 258, transmit processor 264, TX MIMO processor 266, controller/processor 280, or memory 282.

In some aspects, an access point (e.g., access point 124) includes means for receiving, from a station and based at least in part on a PTK that is derived using an Snonce and an Anonce, a reassociation request that indicates MIC information; means for transmitting, to the station, a reassociation response that indicates MIC information; and/or means for performing a reassociation with the station based at least in part on the reassociation response. In some aspects, the means for the access point to perform operations described herein may include, for example, one or more of transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

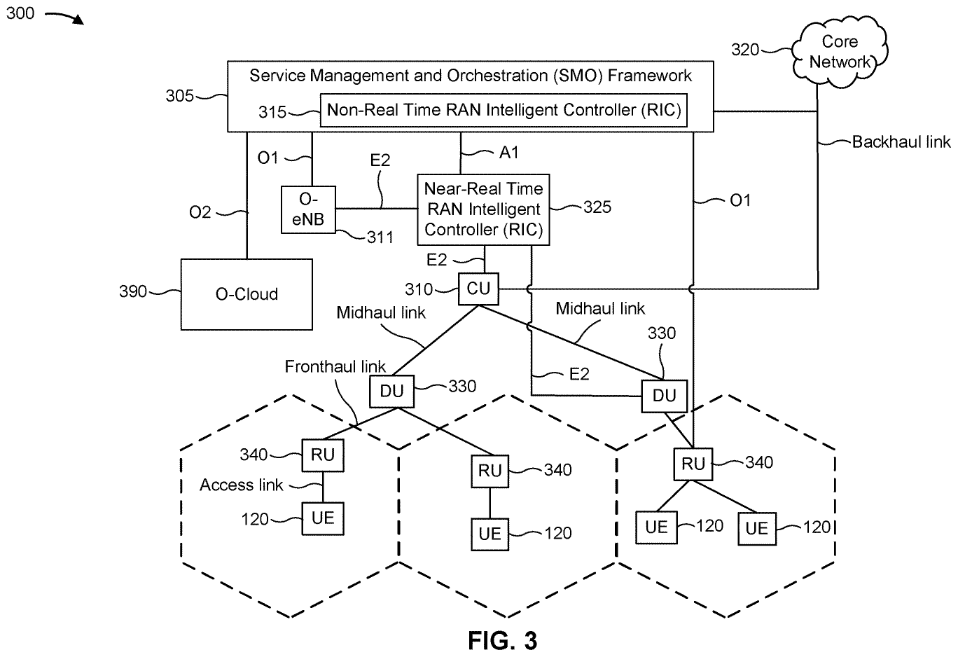

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

Many popular applications may support Wi-Fi Protected Access II (WPA2) pre-shared keys (PSKs), but an Institute of Electrical and Electronics Engineers (IEEE) 802.11w feature may be disabled by default. Disabling the IEEE 802.11w feature may result in a defect during a roam scenario in a WPA2 non-802.11w extended service set (ESS). The defect may be an increased susceptibility to downgrade attacks during the roam scenario in the WPA2 non-802.11w ESS. The IEEE 802.11w feature may increase a security of management frames. The IEEE 802.11w feature may increase security by providing data confidentiality of management frames, mechanisms that enable data integrity, data origin authenticity, and replay protection. In a Wi-Fi Protected Access III (WPA3) Simultaneous Authentication of Equals (SAE), the IEEE 802.11w feature may be mandatory (e.g., the IEEE 802.11 feature may be enabled), such that the defect may not be present in a WPA3 network. However, enabling the IEEE 802.11w feature may introduce an additional latency (e.g., more than 1000 ms) in some roam scenarios. This additional latency may also be present in some WPA2 IEEE 802.11w enabled networks. An approach to resolve the defect (e.g., the increased susceptibility to downgrade attacks) and the additional latency in WPA2 PSK and WPA3 SAE networks may be needed.

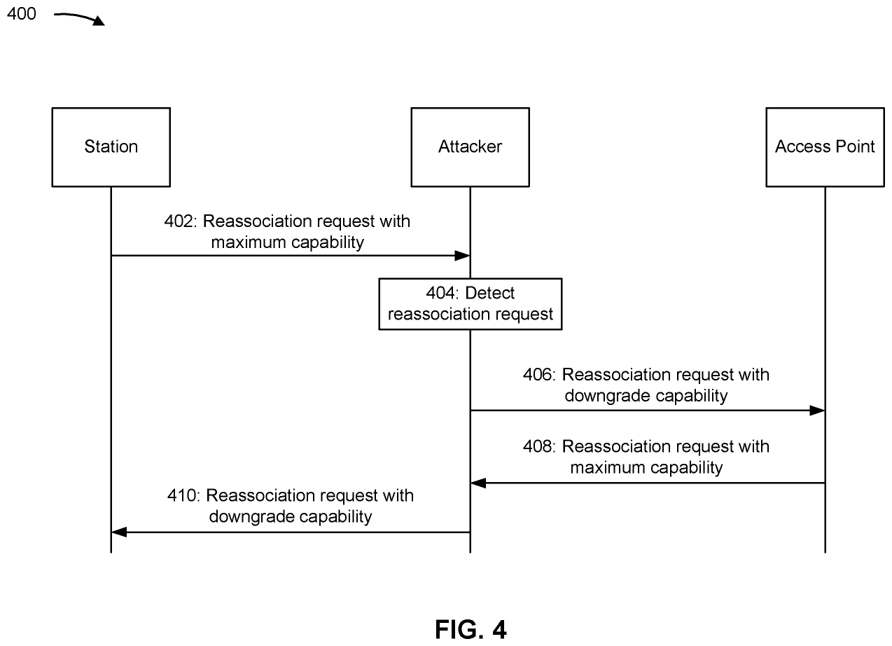

FIG. 4 is a diagram illustrating an example 400 of a WPA2 PSK with an IEEE 802.11w disabled ESS, in accordance with the present disclosure.

As shown by reference number 402, for a WPA2 PSK with an IEEE 802.11w disabled ESS and during an ESS roam scenario, a station may transmit a reassociation request to an access point. The reassociation request may indicate a maximum capability of the station. As shown by reference number 404, an attacker may detect the reassociation request. As shown by reference number 406, the attacker may transmit a reassociation request with a downgrade capability to the access point. In other words, the attacker may reassemble the reassociation request received from the station with the downgrade capability, and the attacker may transmit the reassociation request with the downgrade capability to the access point, as part of a downgrade attack. The reassociation request may be modified with downgraded capabilities (e.g., a reduction in throughput). The downgrade attack may be a man-in-the-middle attack. As shown by reference number 408, the access point may transmit a reassociation response with a maximum capability. As shown by reference number 410, the attacker may receive the reassociation request with the maximum capability, and the attacker may transmit a reassociation response with the downgrade capability to the station. As a result, the station may be indicted with the downgrade capability due to the downgrade attack.

As indicated above, FIG. 4 is provided as an example. Other examples may differ from what is described with regard to FIG. 4.

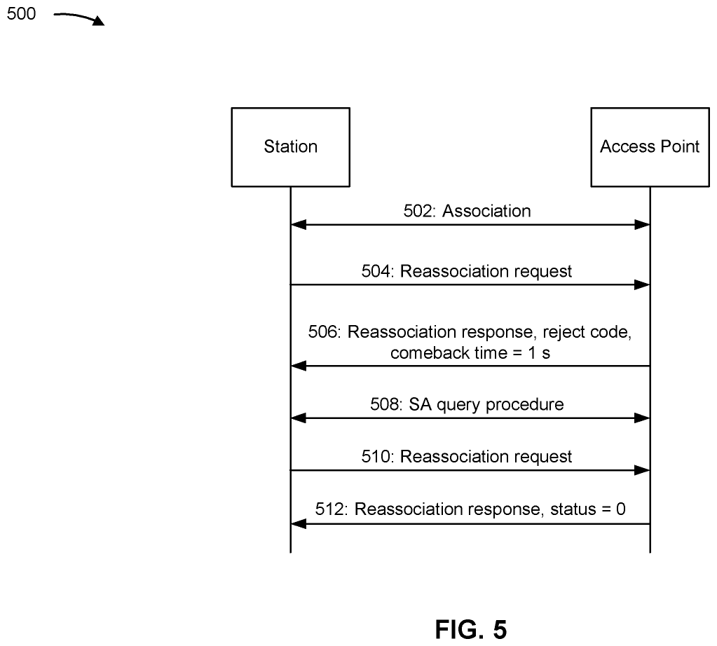

FIG. 5 is a diagram illustrating an example 500 of a WPA3 SAE with an IEEE 802.11w enabled ESS, in accordance with the present disclosure.

As shown by reference number 502, for a WPA3 SAE with an IEEE 802.11w enabled ESS and during an ESS roam scenario, a station may perform an association with an access point. As shown by reference number 504, the station may transmit a reassociation request to the access point. As shown by reference number 506, the station may receive a reassociation response from the access point. The reassociation response may include a reject code (e.g., reject code=0x1E) and may be associated with a comeback time of approximately one second. The access point may transmit the reject code based at least in part on the reassociation response (e.g., when the reassociation response has been reassembled due to a downgrade attack). As shown by reference number 508, the station may perform a security association (SA) query procedure with the access point, which may consume approximately one second. As shown by reference number 510, the station may transmit another reassociation request to the access point. As shown by reference number 512, the station may receive another reassociation response from the access point, where the reassociation response may indicate a status (e.g., status=0). With the WPA3 SAE with the IEEE 802.11w enabled ESS, the station may avoid a downgrade attack because the reassociation request may not be intercepted by an attacker, but may be subject to an additional latency (e.g., one second) in association time (e.g., during the SA query procedure). The additional latency may be undesirable in the ESS roam scenario.

As indicated above, FIG. 5 is provided as an example. Other examples may differ from what is described with regard to FIG. 5.

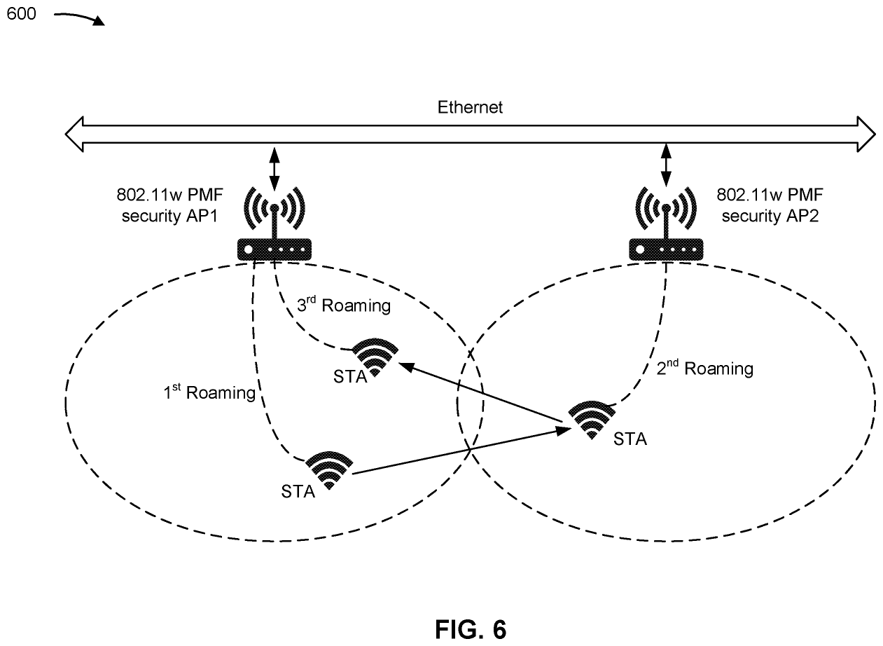

FIG. 6 is a diagram illustrating an example 600 of an ESS roaming scenario, in accordance with the present disclosure.

As shown in FIG. 6, a station (STA) may be associated with a first IEEE 802.11w protected management frame (PMF) security access point (AP1) after a first roaming. The station may be associated with a second IEEE 802.11w PMF security access point (AP2) after a second roaming. After a third roaming, the station may be back within a range of the first IEEE 802.11w PMF security access point. The station may transmit a reassociation request to the first IEEE 802.11w PMF security access point, but the first IEEE 802.11w PMF security access point may respond with a reassociation response having a reject code (e.g., reject code=0x1E). As a result, the station may need to wait for a time interval to retry roaming to the first IEEE 802.11w PMF security access point, which may result in a relatively long latency (e.g., more than 1000 ms, which may correspond to a roam back latency since the station is attempting to roam back to the first IEEE 802.11w PMF security access point). The station may attempt to roam back to the first IEEE 802.11w PMF security access point, but the first IEEE 802.11w PMF security access point may issue the reject code due to a PMF security mechanism. The reject code may indicate that an association request is rejected temporarily, and that the station should try again later.

As indicated above, FIG. 6 is provided as an example. Other examples may differ from what is described with regard to FIG. 6.

A WPA2 non-IEEE 802.11w network (e.g., a network in which IEEE 802.11w is disabled) may be vulnerable to downgrade attacks. Disabling an IEEE 802.11w feature may result in a defect during a roam scenario in a WPA2 non-802.11w ESS, where the defect may be an increased susceptibility to downgrade attacks during the roam scenario in the WPA2 non-802.11w ESS. Further, in a WPA3 and WPA2 IEEE 802.11w enabled ESS roam scenario (e.g., in which IEEE 802.11w is enabled), an additional latency (e.g., an additional one second of latency) may be present, which may be undesirable for the ESS roam scenario. As a result, resolving the vulnerability to downgrade attacks and resolving the additional latency may be desired.

In various aspects of techniques and apparatuses described herein, a station may transmit an Snonce to an access point. The station may receive an Anonce from the access point. The station may transmit the Snonce and receive the Anonce based at least in part on an SAE authentication and a vendor information element (IE) format, or based at least in part on an open authentication and a vendor IE format. The station may determine a PTK based at least in part on the Snonce and the Anonce. The station may transmit, to the access point and using the PTK, a reassociation request that indicates MIC information. The MIC information in the reassociation request may indicate whether the reassociation request has been reassembled due to a downgrade attack. The station may receive, from the access point, a reassociation response that indicates MIC information. The MIC information in the reassociation response may indicate whether the reassociation response has been reassembled due to the downgrade attack. The station may perform a reassociation with the access point based at least in part on a receipt of the reassociation response.

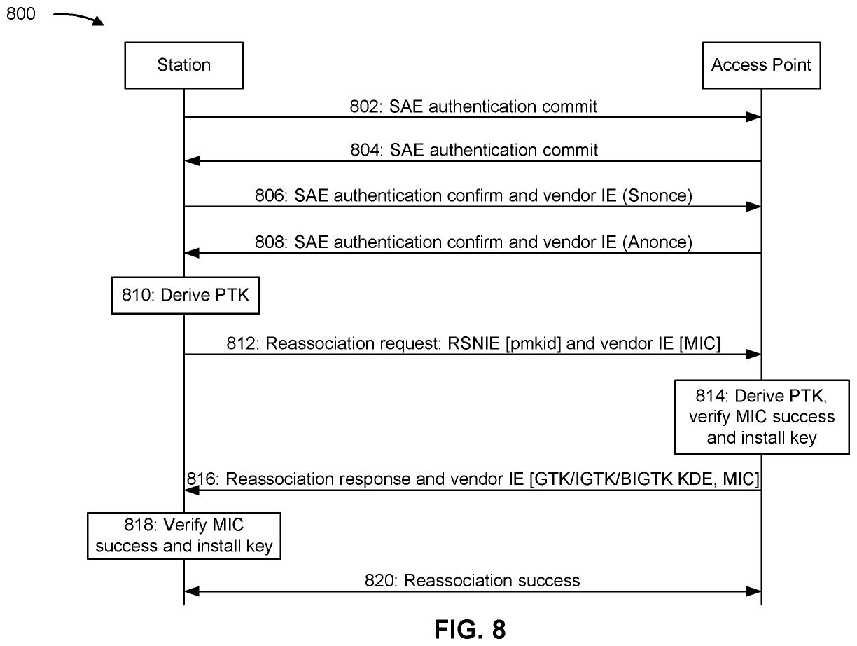

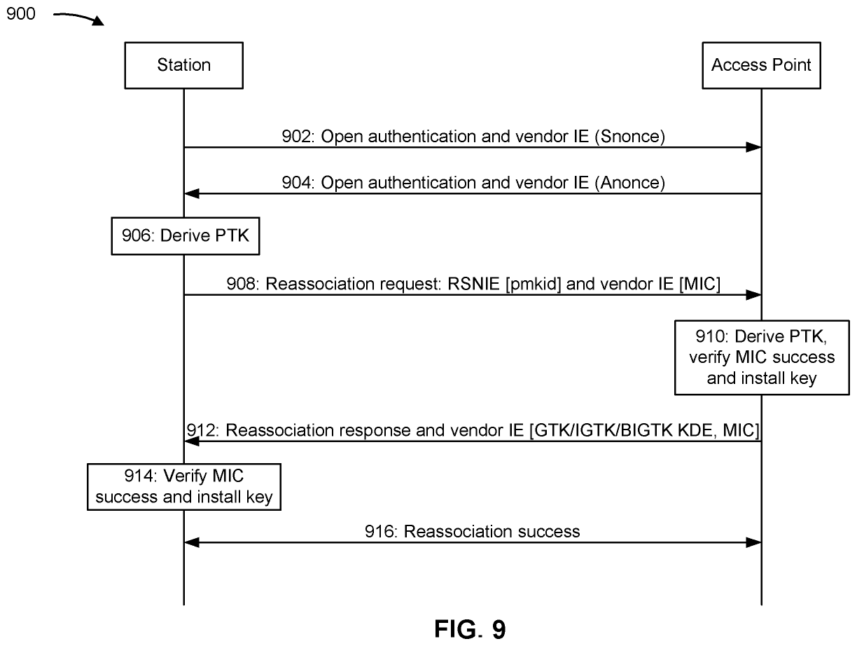

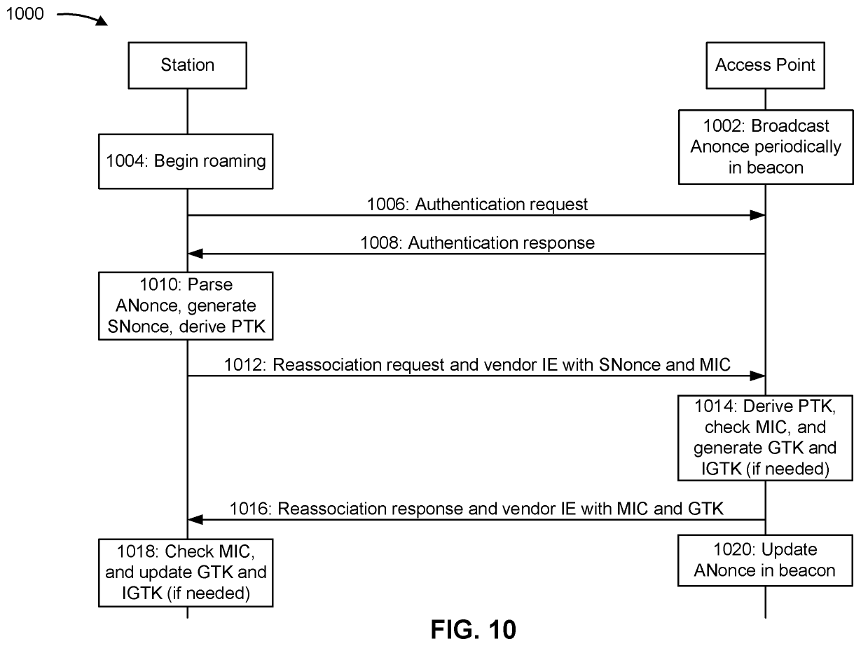

In some aspects, the Snonce/Anonce may be exchanged (or determined) before a reassociation via an SAE authentication when a pairwise master key security association (PMKSA) does not exist (as shown in FIG. 8), via an open authentication when a PMKSA does exist (as shown in FIG. 9), or via a broadcast of the Anonce and a derivation of the Snonce based at least in part on the Anonce (as shown in FIG. 10).

Such approaches may avoid a downgrade attack because when an attacker reassembles a reassociation request or a reassociation response, an MIC check may fail. When an MIC failure occurs, an access point rollback to an SA query may be performed, as defined in the IEEE 802.11 specification. Further, such approaches may reduce a roaming back latency from 1000 ms to 100 ms in case a PMF AP reject with reason “Association request rejected temporarily; try again later” is issued. The roaming back latency may occur when the station moves from a first access point to a second access point, and then attempts to return to the first access point. The access point may be subjected to the roaming back latency (e.g., more than one second) when attempting to return back to the first access point. Reassociation request messages may include a vendor IE, as described herein, to avoid the PMF AP reject. An overall latency may be reduced since a MIC and distribute keys may be encapsulated in (re)association frames. Such approaches may be useful to Wi-Fi vendors and mobile manufacturers that experience the problems of downgrade attacks in an IEEE 802.11w PMF network, as well as long roaming latency in a roam back scenario.

In some aspects, a roaming security may be enhanced in a non-IEEE 802.11w network. The vendor IE may be added to calculate the MIC information in the reassociation request and the MIC information in the reassociation response, which may enhance the roaming security in the non-IEEE 801.11w network. Further, a one second latency in an IEEE 802.11w network in which a WPA2 802.11w feature is enabled may be reduced when a pairwise master key (PMK) exists. A one second latency in WPA3-SAE network in which the 802.11w feature is mandatory may be reduced, irrespective of whether the PMK exists or does not exist.

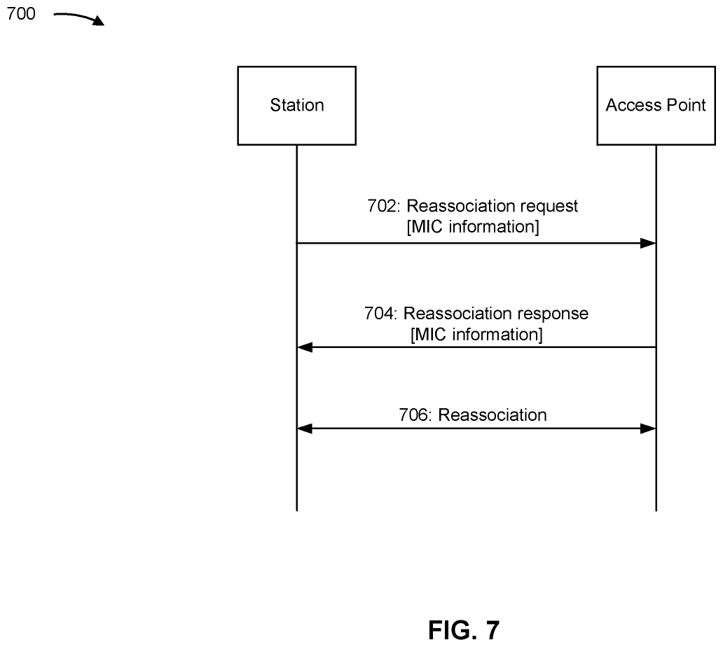

FIG. 7 is a diagram illustrating an example 700 associated with reassociation between a station and an access point, in accordance with the present disclosure. As shown in FIG. 7, communication may occur between a station (e.g., station 120) and an access point (e.g., access point 124). In some aspects, the station and the access point may be included in a wireless network, such as wireless network 100.

As shown by reference number 702, the station may transmit, to the access point, a reassociation request. The station may transmit the reassociation request using a PTK, which may be based at least in part on an Snonce and an Anonce. The Snonce may be a random number generated by the station. The Anonce may be a random number generated by the access point. The reassociation request may indicate MIC information. The MIC information in the reassociation request may indicate whether the reassociation request has been reassembled due to a downgrade attack. The reassociation request may indicates a pairwise master key identifier (PMKID) and the MIC information. The access point may check the MIC information in the reassociation request to determine whether the reassociation request has been reassembled due to a downgrade attack, where an MIC failure may indicate an existence of the downgrade attack.

In some aspects, the station may transmit the Snonce to the access point, and the station may receive the Anonce from the access point. In some aspects, a PMKSA may be not enabled. The station may transmit the Snonce and receive the Anonce based at least in part on an SAE authentication and a vendor IE format. In some aspects, the PMKSA may be enabled. The station may transmit the Snonce and receive the Anonce based at least in part on an open authentication and a vendor IE format. In some aspects, the station may receive, from the access point, the Anonce via a periodic broadcast of the Anonce in a beacon, where the Anonce may be parsed and the PTK may be generated based at least in part on the Anonce. The station may generate the Snonce independent of the Anonce (e.g., the Snonce generated by the station may not be related to the Anonce).

In some aspects, the reassociation request and the reassociation response may be associated with the vendor IE format. The vendor IE format may indicate an IE identifier, an IE length, an organizationally unique identifier (OUI), a type, the Snonce or the Anonce, an encrypted data length, encrypted data, and MIC information. In some aspects, the PTK may be based at least in part on a pseudo-random function (PRF), a PMK, an authenticator address (AA) associated with the access point, a supplicant address (SPA) associated with the station, the Anonce, and the Snonce, where the PTK may be derived prior to the reassociation request being transmitted.

In some aspects, the reassociation request may be unencrypted, and the MIC information indicated in the reassociation request based at least in part on a key confirmation key (KCK). The station may determine the KCK based at least in part on the PTK, which may be derived before the station transmits the reassociation request.

As shown by reference number 704, the station may receive, from the access point, a reassociation response. The reassociation response may indicate MIC information. The MIC information in the reassociation response may indicate whether the reassociation response has been reassembled due to the downgrade attack. The station may check the MIC information in the reassociation response to determine whether the reassociation response has been reassembled due to a downgrade attack.

The reassociation response may indicate a group temporal key (GTK), an integrity group temporal key (IGTK), a beacon integrity group temporal key (BIGTK) key data encapsulation (KDE), and the MIC information As shown by reference number 706, the station may perform a reassociation with the access point based at least in part on a receipt of the reassociation response.

The station may perform the reassociation based at least in part on the MIC information indicated in the reassociation response, where the MIC information may indicate that the reassociation response has not been reassembled due to the downgrade attack. In some aspects, the station may be associated with a roam scenario in a non-IEEE 802.11w network, or the station may be associated with a roam scenario in an IEEE 802.11w enabled network. The station and the access point may support a WPA2-PSK or a WPA3-SAE.

As indicated above, FIG. 7 is provided as an example. Other examples may differ from what is described with regard to FIG. 7.

FIG. 8 is a diagram illustrating an example 800 associated with reassociation between a station and an access point, in accordance with the present disclosure. As shown in FIG. 8, communication may occur between a station (e.g., station 120) and an access point (e.g., access point 124). In some aspects, the station and the access point may be included in a wireless network, such as wireless network 100.

In some aspects, the station (or STA) may be a device having a capability to use an 802.11 protocol. The station may be a mobile phone (or Wi-Fi phone), a laptop, a desktop computer, or the like. The station may be fixed or mobile. “Station” may be used interchangeably with “client” or “UE”. The station may also be referred to as a transmitter or a receiver based at least in part on its transmission characteristics. The station may be any device that contains an IEEE 802.11-conformant media access control (MAC) and physical layer (PHY) interface to a wireless medium.

In some aspects, the station and the access point may exchange an Anonce and an Snonce. The Anonce may be a random number generated by the access point (authenticator), and the Snonce may be a random number generated by the station (supplicant). The station and the access point may exchange the Anonce and the Snonce between a reassociation by using an open authentication (e.g., when a PMKSA exists) or an SAE authentication (e.g., when PMKSA does not exist). Then, before a reassociation request, which may be associated with a roaming event, a PTK may already be derived by both the station and the access point. The PTK may be based at least in part on the Anonce and the Snonce. The PTK may be used to encrypt unicast traffic between the station and the access point. The PTK may be unique between the station and the access point.

In some aspects, in the reassociation request, the station may perform a MIC for the reassociation request and attach MIC information in a vendor IE. When the access point receives this reassociation request with the MIC information, the access point may check whether the reassociation request is reassembled or not, which may be based at least in part on the MIC information. By checking whether the reassociation request is reassembled, the access point may determine whether the reassociation request is subjected to a downgrade attack. Similarly, in a reassociation response, the access point may perform an MIC for a reassociation response and attach MIC information in a vendor IE. When the station receives this reassociation response with the MIC information, the station may check whether the reassociation response is reassembled or not, which may be based at least in part on the MIC information. By checking whether the reassociation response is reassembled, the station may determine whether the reassociation response is associated with the downgrade attack.

As shown by reference number 802, when PMKSA does not exist and in a roam scenario, the station may transmit an SAE authentication commit message to the access point. As shown by reference number 804, the access point may transmit an SAE authentication commit message to the station. As shown by reference number 806, the station may transmit, to the access point, an SAE authentication confirm message and vendor IE, which may indicate the Snonce. As shown by reference number 808, the access point may transmit, to the station, an SAE authentication confirm message and vendor IE, which may indicate the Anonce. In other words, the station and the access point may exchange the Snonce/Anonce using a third and fourth message (e.g., a confirm message in a vendor IE). As shown by reference number 810, the station may derive the PTK after an SAE authentication is complete. The PTK may be derived based at least in part on the following: PTK=PRF−Length(PMK, “Pairwise key expansion”, Min(AA, SPA)∥Max(AA, SPA)∥Min(Anonce, Snonce)∥Max(Anonce, Snonce), where PRF is pseudo-random function, PMK is a pairwise master key, AA is an authenticator address associated with the access point, and SPA is a supplicant address associated with the station.

As shown by reference number 812, the station may transmit a reassociation request to the access point, which may occur after the PTK is derived by both the station and the access point. The reassociation request may indicate a robust security network (RSN) IE, which may indicate a PMKID, and a vendor IE, which may indicate a MIC. In the reassociation request, the station may calculate the MIC and attach the MIC (or MIC result) in the vendor IE as a last IE. The station may calculate the MIC based at least in part on a KCK and reassociation request frame IEs. As shown by reference number 814, the access point may receive the reassociation request, and the access point may derive the PTK, verify an MIC success and install a key based at least in part on a verification of the MIC success. The access point may receive the reassociation request and then perform an MIC check using the MIC indicated in the reassociation request.

When the access point determines that the MIC passes the MIC check, resulting in the MIC success, the access point may calculate the MIC, which may be based at least in part on the KCK and a reassociation response frame body. The station may generate an encrypted MIC and encapsulate the encrypted MIC in the reassociation request, and the access point may decrypt the encrypted MIC and perform an integrity checking (e.g., during the MIC check). As shown by reference number 816, the access point may transmit, to the station, a reassociation response with a vendor IE based at least in part on the MIC success, where the MIC (or MIC result) may be indicated in the vendor IE as a last IE. The reassociation response with the vendor IE may further indicate a GTK, an IGTK, and a BIGTK KDE.

As shown by reference number 818, the station may receive the reassociation response, and the station may verify an MIC success and install a key based at least in part on a verification of the MIC success. The station may receive the reassociation response and then perform an MIC check using the MIC indicated in the reassociation response. The station may determine that the MIC passes the MIC check, resulting in the MIC success. The station may decrypt the GTK, the IGTK, and the BIGTK KDE, as indicated in the reassociation response with the vendor IE. As shown by reference number 820, a reassociation success may be achieved between the station and the access point.

As indicated above, FIG. 8 is provided as an example. Other examples may differ from what is described with regard to FIG. 8.

FIG. 9 is a diagram illustrating an example 900 associated with reassociation between a station and an access point, in accordance with the present disclosure. As shown in FIG. 9, communication may occur between a station (e.g., station 122) and an access point (e.g., access point 124). In some aspects, the station and the access point may be included in a wireless network, such as wireless network 100.

As shown by reference number 902, when PMKSA does exist and in a roam scenario (e.g., a WPA2 roam scenario), the station may transmit, to the access point, an open authentication message and vendor IE, which may indicate an Snonce. As shown by reference number 904, the access point may transmit, to the station, an open authentication message and vendor IE, which may indicate an Anonce. The station and the access point may exchange the Snonce/Anonce using an open authentication frame in the vendor IE. As shown by reference number 906, the station may derive a PTK after an open authentication is complete. The PTK may be derived based at least in part on the following: PTK=PRF−Length(PMK, “Pairwise key expansion”, Min(AA, SPA)∥Max(AA, SPA)∥Min(Anonce, Snonce)∥Max(Anonce, Snonce).

As shown by reference number 908, the station may transmit a reassociation request to the access point, which may occur after the PTK is derived by both the station and the access point. The reassociation request may indicate an RSN IE, which may indicate a PMKID, and a vendor IE, which may indicate a MIC. In the reassociation request, the station may calculate the MIC and attach the MIC (or MIC result) in the vendor IE as a last IE. The station may calculate the MIC based at least in part on a key confirmation key (KCK) and reassociation request frame IEs. As shown by reference number 910, the access point may receive the reassociation request, and the access point may derive the PTK, verify an MIC success and install a key based at least in part on a verification of the MIC success. The access point may receive the reassociation request and then perform an MIC check using the MIC indicated in the reassociation request.

When the access point determines that the MIC passes the MIC check, resulting in the MIC success, the access point may calculate the MIC, which may be based at least in part on the KCK and a reassociation response frame body. As shown by reference number 912, the access point may transmit, to the station, a reassociation response with a vendor IE based at least in part on the MIC success, where the MIC (or MIC result) may be indicated in the vendor IE as a last IE. The reassociation response with the vendor IE may further indicate a GTK, an IGTK, and a BIGTK KDE.

As shown by reference number 914, the station may receive the reassociation response, and the station may verify an MIC success and install a key based at least in part on a verification of the MIC success. The station may receive the reassociation response and then perform an MIC check using the MIC indicated in the reassociation response. The station may determine that the MIC passes the MIC check, resulting in the MIC success. The station may decrypt the GTK, the IGTK, and the BIGTK KDE, as indicated in the reassociation response with the vendor IE. As shown by reference number 916, a reassociation success may be achieved between the station and the access point.

In some aspects, the vendor IE may be associated with a vendor IE format.

The vendor IE format may include an IE identifier field, which may include a value that is one octet. The value may be set to “0xDD” (e.g., vendor specific) as specified in an 802.11 baseline specification. The vendor IE format may include a length field, which may include a value that is one octet. The value may correspond to a length of IE bodies. The vendor IE format may include an OUI field, which may include a value that is three octets. An OUI may uniquely identify a vendor, manufacturer, or other organization. The vendor IE format may include a type field, which may include a value that is one octet. The vendor IE format may include a nonce field (e.g., Snonce or Anonce), which may include a variable value that is 32 octets. The Snonce may correspond to a frame that is transmitted from the station to the access point, and the Anonce may correspond to a frame that is transmitted from the access point to the station. The vendor IE format may include an encrypted data length field, which may include a variable value that is a variable quantity of octets. The encrypted data length field may correspond to a length of encrypted data (e.g., “0” when transmitting from the station to the access point). The vendor IE format may include encrypted data, which may include a variable value that is a variable quantity of octets. The encrypted data may be associated with an encrypted GTK, IGTK, and BIGTK KDE from the access point by a key encryption key (KEK). The vendor IE format may include a MIC, which may include a variable value that is 16 or 24 octets. The MIC may be computed over a body of the re(association) request/response frame (with an MIC field first zeroed before a computation).

As indicated above, FIG. 9 is provided as an example. Other examples may differ from what is described with regard to FIG. 9.

FIG. 10 is a diagram illustrating an example 1000 associated with reassociation between a station and an access point, in accordance with the present disclosure. As shown in FIG. 10, communication may occur between a station (e.g., station 122) and an access point (e.g., access point 124). In some aspects, the station and the access point may be included in a wireless network, such as wireless network 100.

As shown by reference number 1002, the access point may broadcast an Anonce periodically via a beacon. As shown by reference number 1004, the station may begin roaming. Initially, the station may be configured with a PMKID. As shown by reference number 1006, the station may transmit an authentication request to the access point. As shown by reference number 1008, the access point may transmit an authentication response to the station. As shown by reference number 1010, the station may parse the Anonce, which may be received by the station based at least in part on a periodic broadcast of the Anonce via the beacon. The station may parse the Anonce.

The station may derive a PTK based at least in part on the Anonce and the Snonce. For example, the station may derive the PTK based at least in part on PRF(PMK, AA, SPA, Snonce, Anonce). The station may determine a KCK, a KEK, and a temporal key (TK) based at least in part on the PTK. The station may calculate a MIC based at least in part on the KCK and reassociation request frame IEs. As shown by reference number 1012, the station may transmit, to the access point, a reassociation request and vendor IE, which may indicate the Snonce and the MIC. As shown by reference number 1014, the access point may derive the PTK and check the MIC. The access point may determine that the MIC passes a MIC check, resulting in a MIC success. The access point may generate a GTK and IGTK if needed. As shown by reference number 1016, the access point may transmit, to the station, a reassociation response and vendor IE, which may indicate the MIC and the GTK. As shown by reference number 1018, the station may check the MIC. The station may determine that the MIC passes a MIC check, resulting in a MIC success. The station may update the GTK and IGTK if needed. As shown by reference number 1020, the access point may update the Anonce that is periodically broadcasted via the beacon.

As indicated above, FIG. 10 is provided as an example. Other examples may differ from what is described with regard to FIG. 10.

FIG. 11 is a diagram illustrating an example process 1100 performed, for example, by a station, in accordance with the present disclosure. Example process 1100 is an example where the station (e.g., station 122) performs operations associated with reassociation between a station and an access point.

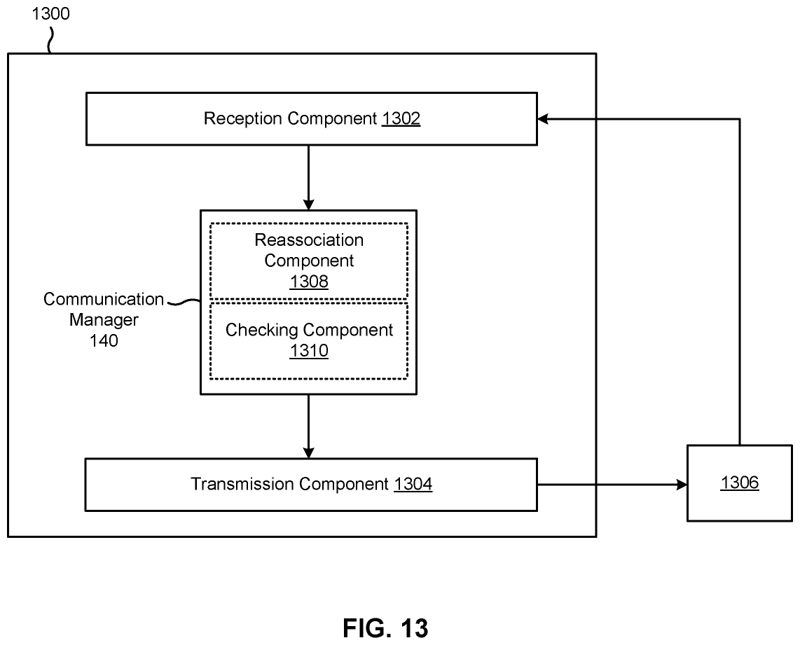

As shown in FIG. 11, in some aspects, process 1100 may include transmitting, to an access point and using a PTK that is based at least in part on an Snonce and an Anonce, a reassociation request that indicates MIC information (block 1110). For example, the station (e.g., using communication manager 140 and/or transmission component 1304, depicted in FIG. 13) may transmit, to an access point and using a PTK that is based at least in part on an Snonce and an Anonce, a reassociation request that indicates MIC information, as described above.

As further shown in FIG. 11, in some aspects, process 1100 may include receiving, from the access point, a reassociation response that indicates MIC information (block 1120). For example, the station (e.g., using communication manager 140 and/or reception component 1302, depicted in FIG. 13) may receive, from the access point, a reassociation response that indicates MIC information, as described above.

As further shown in FIG. 11, in some aspects, process 1100 may include performing a reassociation with the access point based at least in part on a receipt of the reassociation response (block 1130). For example, the station (e.g., using communication manager 140 and/or reassociation component 1308, depicted in FIG. 13) may perform a reassociation with the access point based at least in part on a receipt of the reassociation response, as described above.

Process 1100 may include additional aspects, such as any single aspect or any combination of aspects described below and/or in connection with one or more other processes described elsewhere herein.

In a first aspect, process 1100 includes transmitting the Snonce to the access point and receiving the Anonce from the access point based at least in part on an SAE authentication and a vendor IE format.

In a second aspect, alone or in combination with the first aspect, process 1100 includes transmitting the Snonce to the access point and receiving the Anonce from the access point based at least in part on open authentication and a vendor IE format.

In a third aspect, alone or in combination with one or more of the first and second aspects, the reassociation request and the reassociation response is associated with a vendor IE format, wherein the vendor IE format indicates an IE identifier, an IE length, an OUI, a type, the Snonce or the Anonce, an encrypted data length, encrypted data, and MIC information, and the Snonce is a random number generated by the station and the Anonce is a random number generated by the access point.

In a fourth aspect, alone or in combination with one or more of the first through third aspects, the MIC information in the reassociation request indicates whether the reassociation request has been reassembled due to a downgrade attack, and the MIC information in the reassociation response indicates whether the reassociation response has been reassembled due to the downgrade attack, wherein the MIC information in the reassociation request is based at least in part on a KCK that is derived using the PTK.

In a fifth aspect, alone or in combination with one or more of the first through fourth aspects, process 1100 includes checking the MIC information in the reassociation response for determining whether the reassociation response has been reassembled due to a downgrade attack, wherein an MIC failure indicates an existence of the downgrade attack.

In a sixth aspect, alone or in combination with one or more of the first through fifth aspects, the reassociation request indicates a PMKID and the MIC information.

In a seventh aspect, alone or in combination with one or more of the first through sixth aspects, the reassociation response indicates a GTK, an IGTK, a BIGTK KDE, and the MIC information.

In an eighth aspect, alone or in combination with one or more of the first through seventh aspects, process 1100 includes receiving, from the access point, the Anonce via a periodic broadcast of the Anonce in a beacon, wherein the Anonce is parsed and the PTK is generated based at least in part on the Anonce.

In a ninth aspect, alone or in combination with one or more of the first through eighth aspects, the PTK is based at least in part on a PRF, a PMK, an AA associated with the access point, an SPA associated with the station, the Anonce, and the Snonce, and the PTK is derived prior to the reassociation request being transmitted.

In a tenth aspect, alone or in combination with one or more of the first through ninth aspects, a PMKSA is enabled or not enabled.

In an eleventh aspect, alone or in combination with one or more of the first through tenth aspects, the station is associated with a roam scenario in a non-IEEE 802.11w network.

In a twelfth aspect, alone or in combination with one or more of the first through eleventh aspects, the station is associated with a roam scenario in an IEEE 802.11w enabled network.

In a thirteenth aspect, alone or in combination with one or more of the first through twelfth aspects, the station and the access point support a WPA2-PSK or a WPA3-SAE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by an access point, in accordance with the present disclosure. Example process 1200 is an example where the access point (e.g., access point 124) performs operations associated with reassociation between a station and an access point.

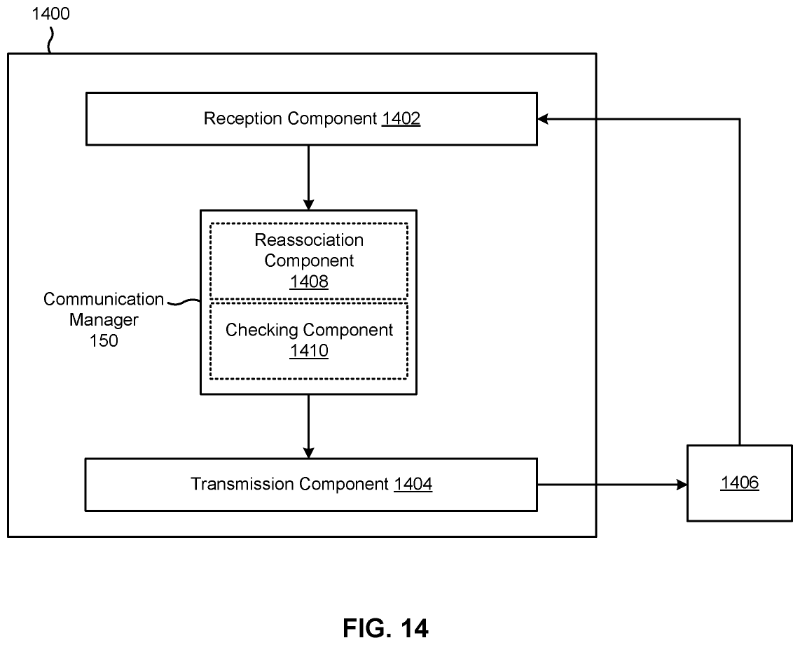

As shown in FIG. 12, in some aspects, process 1200 may include receiving, from a station and based at least in part on a PTK that is derived using an Snonce and an Anonce, a reassociation request that indicates MIC information (block 1210). For example, the access point (e.g., using communication manager 150 and/or reception component 1402, depicted in FIG. 14) may receive, from a station and based at least in part on a PTK that is derived using an Snonce and an Anonce, a reassociation request that indicates MIC information, as described above.

As further shown in FIG. 12, in some aspects, process 1200 may include transmitting, to the station, a reassociation response that indicates MIC information (block 1220). For example, the access point (e.g., using communication manager 150 and/or transmission component 1404, depicted in FIG. 14) may transmit, to the station, a reassociation response that indicates MIC information, as described above.

As further shown in FIG. 12, in some aspects, process 1200 may include performing a reassociation with the station based at least in part on the reassociation response (block 1230). For example, the access point (e.g., using communication manager 150 and/or reassociation component 1408, depicted in FIG. 14) may perform a reassociation with the station based at least in part on the reassociation response, as described above.

Process 1200 may include additional aspects, such as any single aspect or any combination of aspects described below and/or in connection with one or more other processes described elsewhere herein.

In a first aspect, process 1200 includes transmitting the Anonce to the station and receiving the Snonce from the station based at least in part on an SAE authentication and a vendor IE format.

In a second aspect, alone or in combination with the first aspect, process 1200 includes transmitting the Anonce to the station and receiving the Snonce from the station based at least in part on open authentication and a vendor IE format.

In a third aspect, alone or in combination with one or more of the first and second aspects, the reassociation request and the reassociation response is associated with a vendor IE format, wherein the vendor IE format indicates an IE identifier, an IE length, an OUI, a type, the Snonce or the Anonce, an encrypted data length, encrypted data, and MIC information, and the Snonce is a random number generated by the station and the Anonce is a random number generated by the access point.

In a fourth aspect, alone or in combination with one or more of the first through third aspects, the MIC information in the reassociation request indicates whether the reassociation request has been reassembled due to a downgrade attack, and the MIC information in the reassociation response indicates whether the reassociation response has been reassembled due to the downgrade attack, wherein the MIC information in the reassociation request is based at least in part on a KCK that is derived using the PTK.

In a fifth aspect, alone or in combination with one or more of the first through fourth aspects, process 1200 includes checking the MIC information in the reassociation request for determining whether the reassociation request has been reassembled due to a downgrade attack, wherein an MIC failure indicates an existence of the downgrade attack.

In a sixth aspect, alone or in combination with one or more of the first through fifth aspects, the reassociation request indicates a PMKID and the MIC information.

In a seventh aspect, alone or in combination with one or more of the first through sixth aspects, the reassociation response indicates a GTK, an IGTK, a BIGTK KDE, and the MIC information.

In an eighth aspect, alone or in combination with one or more of the first through seventh aspects, process 1200 includes transmitting, to the station, the Anonce via a periodic broadcast of the Anonce in a beacon, wherein the Anonce is parsed and the PTK is generated based at least in part on the Anonce.

In a ninth aspect, alone or in combination with one or more of the first through eighth aspects, the PTK is based at least in part on a PRF, a PMK, an AA associated with the access point, an SPA associated with the station, the Anonce, and the Snonce, and the PTK is derived prior to the reassociation request being transmitted.

In a tenth aspect, alone or in combination with one or more of the first through ninth aspects, a PMKSA is enabled or not enabled.

In an eleventh aspect, alone or in combination with one or more of the first through tenth aspects, the station is associated with a roam scenario in a non-IEEE 802.11w network.

In a twelfth aspect, alone or in combination with one or more of the first through eleventh aspects, the station is associated with a roam scenario in an IEEE 802.11w enabled network.

In a thirteenth aspect, alone or in combination with one or more of the first through twelfth aspects, the station and the access point support a WPA2-PSK or WPA3-SAE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a station, or a station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a reassociation component 1308, or a checking component 1310, among other examples.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the station described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the station described in connection with FIG. 2. In some aspects, the transmission component 1304 may be co-located with the reception component 1302 in a transceiver.

The transmission component 1304 may transmit, to an access point and using a PTK that is based at least in part on an Snonce and an Anonce, a reassociation request that indicates MIC information. The reception component 1302 may receive, from the access point, a reassociation response that indicates MIC information. The reassociation component 1308 may perform a reassociation with the access point based at least in part on a receipt of the reassociation response.

The transmission component 1304 may transmit the Snonce to the access point and receiving the Anonce from the access point based at least in part on an SAE authentication and a vendor IE format. The transmission component 1304 may transmit the Snonce to the access point and receiving the Anonce from the access point based at least in part on open authentication and a vendor IE format. The checking component 1310 may check the MIC information in the reassociation response for determining whether the reassociation response has been reassembled due to a downgrade attack, wherein an MIC failure indicates an existence of the downgrade attack. The reception component 1302 may receive, from the access point, the Anonce via a periodic broadcast of the Anonce in a beacon, wherein the Anonce is parsed and the PTK is generated based at least in part on the Anonce.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a access point, or a access point may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include one or more of a reassociation component 1408, or a checking component 1410, among other examples.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the access point described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the access point described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the access point described in connection with FIG. 2. In some aspects, the transmission component 1404 may be co-located with the reception component 1402 in a transceiver.

The reception component 1402 may receive, from a station and based at least in part on a PTK that is derived using an Snonce and an Anonce, a reassociation request that indicates MIC information. The transmission component 1404 may transmit, to the station, a reassociation response that indicates MIC information. The reassociation component 1408 may perform a reassociation with the station based at least in part on the reassociation response.

The transmission component 1404 may transmit the Anonce to the station and receiving the Snonce from the station based at least in part on an SAE authentication and a vendor IE format. The transmission component 1404 may transmit the Anonce to the station and receiving the Snonce from the station based at least in part on open authentication and a vendor IE format. The checking component 1410 may check the MIC information in the reassociation request for determining whether the reassociation request has been reassembled due to a downgrade attack, wherein an MIC failure indicates an existence of the downgrade attack. The transmission component 1404 may transmit, to the station, the Anonce via a periodic broadcast of the Anonce in a beacon, wherein the Anonce is parsed and the PTK is generated based at least in part on the Anonce.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a station, comprising: transmitting, to an access point and using a pairwise transient key (PTK) that is based at least in part on an Snonce and an Anonce, a reassociation request that indicates message integrity check (MIC) information; receiving, from the access point, a reassociation response that indicates MIC information; and performing a reassociation with the access point based at least in part on a receipt of the reassociation response.

Aspect 2: The method of Aspect 1, further comprising: transmitting the Snonce to the access point and receiving the Anonce from the access point based at least in part on a simultaneous authentication of equals (SAE) authentication and a vendor information element format.

Aspect 3: The method of any of Aspects 1 through 2, further comprising: transmitting the Snonce to the access point and receiving the Anonce from the access point based at least in part on open authentication and a vendor information element format.

Aspect 4: The method of any of Aspects 1 through 3, wherein the reassociation request and the reassociation response is associated with a vendor information element (IE) format, wherein the vendor IE format indicates an IE identifier, an IE length, an organizationally unique identifier, a type, the Snonce or the Anonce, an encrypted data length, encrypted data, and MIC information, and wherein the Snonce is a random number generated by the station and the Anonce is a random number generated by the access point.

Aspect 5: The method of any of Aspects 1 through 4, wherein: the MIC information in the reassociation request indicates whether the reassociation request has been reassembled due to a downgrade attack; and the MIC information in the reassociation response indicates whether the reassociation response has been reassembled due to the downgrade attack, wherein the MIC information in the reassociation request is based at least in part on a key confirmation key that is derived using the PTK.

Aspect 6: The method of any of Aspects 1 through 5, further comprising: checking the MIC information in the reassociation response for determining whether the reassociation response has been reassembled due to a downgrade attack, wherein an MIC failure indicates an existence of the downgrade attack.

Aspect 7: The method of any of Aspects 1 through 6, wherein the reassociation request indicates a pairwise master key identifier and the MIC information.

Aspect 8: The method of any of Aspects 1 through 7, wherein the reassociation response indicates a group temporal key, an integrity group temporal key, a beacon integrity group temporal key key data encapsulation, and the MIC information.

Aspect 9: The method of any of Aspects 1 through 8, further comprising: receiving, from the access point, the Anonce via a periodic broadcast of the Anonce in a beacon, wherein the Anonce is parsed and the PTK is generated based at least in part on the Anonce.

Aspect 10: The method of any of Aspects 1 through 9, wherein the PTK is based at least in part on a pseudo-random function, a pairwise master key, an authenticator address associated with the access point, a supplicant address associated with the station, the Anonce, and the Snonce, and wherein the PTK is derived prior to the reassociation request being transmitted.

Aspect 11: The method of any of Aspects 1 through 10, wherein a pairwise master key security association is enabled or not enabled.

Aspect 12: The method of any of Aspects 1 through 11, wherein the station is associated with a roam scenario in a non-Institute of Electrical and Electronics Engineers 802.11w network.

Aspect 13: The method of any of Aspects 1 through 12, wherein the station is associated with a roam scenario in an Institute of Electrical and Electronics Engineers 802.11w enabled network.

Aspect 14: The method of any of Aspects 1 through 13, wherein the station and the access point support a Wi-Fi Protected Access II pre-shared key or Wi-Fi Protected Access III simultaneous authentication of equals.

Aspect 15: A method of wireless communication performed by an access point, comprising: receiving, from a station and based at least in part on a pairwise transient key (PTK) that is derived using an Snonce and an Anonce, a reassociation request that indicates message integrity check (MIC) information; transmitting, to the station, a reassociation response that indicates MIC information; and performing a reassociation with the station based at least in part on the reassociation response.

Aspect 16: The method of Aspect 15, further comprising: transmitting the Anonce to the station and receiving the Snonce from the station based at least in part on a simultaneous authentication of equals (SAE) authentication and a vendor information element format.

Aspect 17: The method of any of Aspects 15 through 16, further comprising: transmitting the Anonce to the station and receiving the Snonce from the station based at least in part on open authentication and a vendor information element format.

Aspect 18: The method of any of Aspects 15 through 17, wherein the reassociation request and the reassociation response is associated with a vendor information element (IE) format, wherein the vendor IE format indicates an IE identifier, an IE length, an organizationally unique identifier, a type, the Snonce or the Anonce, an encrypted data length, encrypted data, and MIC information, and wherein the Snonce is a random number generated by the station and the Anonce is a random number generated by the access point.

Aspect 19: The method of any of Aspects 15 through 18, wherein: the MIC information in the reassociation request indicates whether the reassociation request has been reassembled due to a downgrade attack; and the MIC information in the reassociation response indicates whether the reassociation response has been reassembled due to the downgrade attack, wherein the MIC information in the reassociation request is based at least in part on a key confirmation key that is derived using the PTK.

Aspect 20: The method of any of Aspects 15 through 19, further comprising: checking the MIC information in the reassociation request for determining whether the reassociation request has been reassembled due to a downgrade attack, wherein an MIC failure indicates an existence of the downgrade attack.

Aspect 21: The method of any of Aspects 15 through 20, wherein the reassociation request indicates a pairwise master key identifier and the MIC information.

Aspect 22: The method of any of Aspects 15 through 21, wherein the reassociation response indicates a group temporal key, an integrity group temporal key, a beacon integrity group temporal key key data encapsulation, and the MIC information.

Aspect 23: The method of any of Aspects 15 through 22, further comprising: transmitting, to the station, the Anonce via a periodic broadcast of the Anonce in a beacon, wherein the Anonce is parsed and the PTK is generated based at least in part on the Anonce.

Aspect 24: The method of any of Aspects 15 through 23, wherein the PTK is based at least in part on a pseudo-random function, a pairwise master key, an authenticator address associated with the access point, a supplicant address associated with the station, the Anonce, and the Snonce, and wherein the PTK is derived prior to the reassociation request being transmitted.

Aspect 25: The method of any of Aspects 15 through 24, wherein a pairwise master key security association is enabled or not enabled.

Aspect 26: The method of any of Aspects 15 through 25, wherein the station is associated with a roam scenario in a non-Institute of Electrical and Electronics Engineers 802.11w network.

Aspect 27: The method of any of Aspects 15 through 26, wherein the station is associated with a roam scenario in an Institute of Electrical and Electronics Engineers 802.11w enabled network.

Aspect 28: The method of any of Aspects 15 through 27, wherein the station and the access point support a Wi-Fi Protected Access II pre-shared key or Wi-Fi Protected Access III simultaneous authentication of equals.

Aspect 29: An apparatus for wireless communication at a device, comprising a processor; memory coupled with the processor; and instructions stored in the memory and executable by the processor to cause the apparatus to perform the method of one or more of Aspects 1-14.

Aspect 30: A device for wireless communication, comprising a memory and one or more processors coupled to the memory, the one or more processors configured to perform the method of one or more of Aspects 1-14.

Aspect 31: An apparatus for wireless communication, comprising at least one means for performing the method of one or more of Aspects 1-14.

Aspect 32: A non-transitory computer-readable medium storing code for wireless communication, the code comprising instructions executable by a processor to perform the method of one or more of Aspects 1-14.

Aspect 33: A non-transitory computer-readable medium storing a set of instructions for wireless communication, the set of instructions comprising one or more instructions that, when executed by one or more processors of a device, cause the device to perform the method of one or more of Aspects 1-14.

Aspect 34: An apparatus for wireless communication at a device, comprising a processor; memory coupled with the processor; and instructions stored in the memory and executable by the processor to cause the apparatus to perform the method of one or more of Aspects 15-28.

Aspect 35: A device for wireless communication, comprising a memory and one or more processors coupled to the memory, the one or more processors configured to perform the method of one or more of Aspects 15-28.

Aspect 36: An apparatus for wireless communication, comprising at least one means for performing the method of one or more of Aspects 15-28.

Aspect 37: A non-transitory computer-readable medium storing code for wireless communication, the code comprising instructions executable by a processor to perform the method of one or more of Aspects 15-28.

Aspect 38: A non-transitory computer-readable medium storing a set of instructions for wireless communication, the set of instructions comprising one or more instructions that, when executed by one or more processors of a device, cause the device to perform the method of one or more of Aspects 15-28.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a station, comprising:
a memory; and
one or more processors, coupled to the memory, configured to:
transmit, to an access point and using a pairwise transient key (PTK) that is based at least in part on an Snonce and an Anonce, a reassociation request that indicates message integrity check (MIC) information;
receive, from the access point, a reassociation response that indicates MIC information; and
perform a reassociation with the access point based at least in part on a receipt of the reassociation response.

2. The apparatus of claim 1, wherein the one or more processors are further configured to:
transmit the Snonce to the access point and receive the Anonce from the access point based at least in part on a simultaneous authentication of equals (SAE) authentication and a vendor information element format.

3. The apparatus of claim 1, wherein the one or more processors are further configured to:
transmit the Snonce to the access point and receive the Anonce from the access point based at least in part on open authentication and a vendor information element format.

4. The apparatus of claim 1, wherein the reassociation request and the reassociation response is associated with a vendor information element (IE) format, wherein the vendor IE format indicates an IE identifier, an IE length, an organizationally unique identifier, a type, the Snonce or the Anonce, an encrypted data length, encrypted data, and MIC information, and wherein the Snonce is a random number generated by the station and the Anonce is a random number generated by the access point.

5. The apparatus of claim 1, wherein:
the MIC information in the reassociation request indicates whether the reassociation request has been reassembled due to a downgrade attack; and
the MIC information in the reassociation response indicates whether the reassociation response has been reassembled due to the downgrade attack,
wherein the MIC information in the reassociation request is based at least in part on a key confirmation key that is derived using the PTK.

6. The apparatus of claim 1, wherein the one or more processors are further configured to:
check the MIC information in the reassociation response to determine whether the reassociation response has been reassembled due to a downgrade attack, wherein an MIC failure indicates an existence of the downgrade attack.

7. The apparatus of claim 1, wherein the reassociation request indicates a pairwise master key identifier and the MIC information.

8. The apparatus of claim 1, wherein the reassociation response indicates a group temporal key, an integrity group temporal key, a beacon integrity group temporal key key data encapsulation, and the MIC information.

9. The apparatus of claim 1, wherein the one or more processors are further configured to:
receive, from the access point, the Anonce via a periodic broadcast of the Anonce in a beacon, wherein the Anonce is parsed and the PTK is generated based at least in part on the Anonce.

10. The apparatus of claim 1, wherein the PTK is based at least in part on a pseudo-random function, a pairwise master key, an authenticator address associated with the access point, a supplicant address associated with the station, the Anonce, and the Snonce, and wherein the PTK is derived prior to the reassociation request being transmitted.

11. The apparatus of claim 1, wherein a pairwise master key security association is enabled or not enabled.

12. The apparatus of claim 1, wherein the station is associated with a roam scenario in a non-Institute of Electrical and Electronics Engineers 802.11w network.

13. The apparatus of claim 1, wherein the station is associated with a roam scenario in an Institute of Electrical and Electronics Engineers 802.11w enabled network.

14. The apparatus of claim 1, wherein the station and the access point support a Wi-Fi Protected Access II pre-shared key or Wi-Fi Protected Access III simultaneous authentication of equals.

15. An apparatus for wireless communication at an access point, comprising:
a memory; and
one or more processors, coupled to the memory, configured to:
receive, from a station and based at least in part on a pairwise transient key (PTK) that is derived using an Snonce and an Anonce, a reassociation request that indicates message integrity check (MIC) information;
transmit, to the station, a reassociation response that indicates MIC information; and
perform a reassociation with the station based at least in part on the reassociation response.

16. The apparatus of claim 15, wherein the one or more processors are further configured to:
transmit the Anonce to the station and receive the Snonce from the station based at least in part on a simultaneous authentication of equals (SAE) authentication and a vendor information element format.

17. The apparatus of claim 15, wherein the one or more processors are further configured to:
transmit the Anonce to the station and receive the Snonce from the station based at least in part on open authentication and a vendor information element format.

18. The apparatus of claim 15, wherein the reassociation request and the reassociation response is associated with a vendor information element (IE) format, wherein the vendor IE format indicates an IE identifier, an IE length, an organizationally unique identifier, a type, the Snonce or the Anonce, an encrypted data length, encrypted data, and MIC information, and wherein the Snonce is a random number generated by the station and the Anonce is a random number generated by the access point.

19. The apparatus of claim 15, wherein:
the MIC information in the reassociation request indicates whether the reassociation request has been reassembled due to a downgrade attack; and
the MIC information in the reassociation response indicates whether the reassociation response has been reassembled due to the downgrade attack,
wherein the MIC information in the reassociation request is based at least in part on a key confirmation key that is derived using the PTK.

20. The apparatus of claim 15, wherein the one or more processors are further configured to:
check the MIC information in the reassociation request to determine whether the reassociation request has been reassembled due to a downgrade attack, wherein an MIC failure indicates an existence of the downgrade attack.

21. The apparatus of claim 15, wherein the reassociation request indicates a pairwise master key identifier and the MIC information.

22. The apparatus of claim 15, wherein the reassociation response indicates a group temporal key, an integrity group temporal key, a beacon integrity group temporal key key data encapsulation, and the MIC information.

23. The apparatus of claim 15, wherein the one or more processors are further configured to:
transmit, to the station, the Anonce via a periodic broadcast of the Anonce in a beacon, wherein the Anonce is parsed and the PTK is generated based at least in part on the Anonce.

24. The apparatus of claim 15, wherein the PTK is based at least in part on a pseudo-random function, a pairwise master key, an authenticator address associated with the access point, a supplicant address associated with the station, the Anonce, and the Snonce, and wherein the PTK is derived prior to the reassociation request being transmitted.

25. The apparatus of claim 15, wherein a pairwise master key security association is enabled or not enabled.

26. The apparatus of claim 15, wherein the station is associated with a roam scenario in a non-Institute of Electrical and Electronics Engineers 802.11w network.

27. The apparatus of claim 15, wherein the station is associated with a roam scenario in an Institute of Electrical and Electronics Engineers 802.11w enabled network.

28. The apparatus of claim 15, wherein the station and the access point support a Wi-Fi Protected Access II pre-shared key or Wi-Fi Protected Access III simultaneous authentication of equals.

29. A method of wireless communication performed by a station, comprising:
transmitting, to an access point and using a pairwise transient key (PTK) that is based at least in part on an Snonce and an Anonce, a reassociation request that indicates message integrity check (MIC) information;
receiving, from the access point, a reassociation response that indicates MIC information; and
performing a reassociation with the access point based at least in part on a receipt of the reassociation response.

30. A method of wireless communication performed by an access point, comprising:
receiving, from a station and based at least in part on a pairwise transient key (PTK) that is derived using an Snonce and an Anonce, a reassociation request that indicates message integrity check (MIC) information;
transmitting, to the station, a reassociation response that indicates MIC information; and
performing a reassociation with the station based at least in part on the reassociation response.
